(19) United States
(12) Patent Application Publication
(10) Pub. No.: US 2013/0187550 A1
(43) Pub. Date: Jul. 25, 2013

(54) LED LIGHTING CIRCUIT CAPABLE OF PREVENTING THERMAL BREAKDOWN

(71) Applicants: Yuan-Hung Lo, Taipei City (TW); Wei-Chuan Su, Taipei City (TW); Yen-Hui Wang, Taipei City (TW)

(72) Inventors: Yuan-Hung Lo, Taipei City (TW); Wei-Chuan Su, Taipei City (TW); Yen-Hui Wang, Taipei City (TW)

(21) Appl. No.: 13/354,398

(22) Filed: Jan. 20, 2012

(51) Int. Cl. H05B 37/02

(52) U.S. Cl. 315/122

(57) ABSTRACT

An LED lighting circuit capable of preventing thermal breakdown, including: an LED module, having a top end coupled to a line voltage; and a controller, coupled to the line voltage and a bottom end of the LED module, the controller including: an amplifier, having a positive input end coupled to an adjustable reference voltage; a transistor, having a gate terminal coupled to an output end of the amplifier, a first channel terminal coupled to the bottom end of the LED module, and a second channel terminal coupled to a negative input end of the amplifier; a current sensing resistor, coupled between the second channel terminal and a ground; and a reference voltage generator, used for generating the adjustable reference voltage according to the line voltage.

### BACKGROUND OF THE INVENTION

1. Field of the Invention

The present invention relates to an LED (light emitting diode) lighting circuit, and more particularly to an LED lighting circuit capable of preventing a thermal breakdown caused by high line voltages.

2. Description of the Related Art

Please refer to FIG. 1, which illustrates a prior art LED lighting circuit. As illustrated in FIG. 1, the prior art LED lighting circuit includes a rectifier 110, an LED module 120, and a controller 130.

The rectifier 110, usually a full-wave bridge rectifier, is used to rectify an AC voltage V_{ac} to generate a line voltage V_{LINE}.

The LED module 120, including a plurality of LEDs connected in series, is powered by the line voltage V_{LINE}.

The controller 130, including an amplifier 131, an NMOS transistor 132, and a current sensing resistor 133, is connected between the LED module 120 and a ground to regulate an output current I_{O} flowing through the LED module 120.

The amplifier 131 has a positive input end, a negative input end, and an output end, with the positive input end coupled to a DC reference voltage V_{REF}.

The NMOS transistor 132 has a gate terminal coupled to the output end of the amplifier 131, a drain terminal coupled to the LED module 120, and a source terminal coupled to the negative input end of the amplifier 131.

The current sensing resistor 133 is coupled between the source terminal and the ground.

Due to a virtual short of the positive input end and the negative input end of the amplifier 131 caused by a negative feedback loop, the voltage across the current sensing resistor 133 will be regulated at the DC reference voltage V_{REF}, resulting in a constant value of the output current I_{O}.

However, when the amplitude of the AC voltage V_{ac} increases, the voltage across the controller 130 will increase accordingly, causing much power dissipated in the controller 130. Please refer to FIG. 2, which illustrates a profile of P_{IN} (the power delivered into the LED lighting circuit) and a profile of P_{LED} (the power dissipated in the LED module 120) over the root-mean-square value V_{ac,rms} of the AC voltage V_{ac}. As can be seen in FIG. 2, the difference between P_{IN} and P_{LED} grows as V_{ac,rms} increases. Therefore, a lot of heat can be generated to cause a thermal breakdown of the controller 130 when the difference between P_{IN} and P_{LED} reaches a high value.

To solve the thermal breakdown problem, one solution is to implement additional LEDs in the LED module. Please refer to FIG. 3, which illustrates a prior art LED lighting circuit using additional LEDs. As illustrated in FIG. 3, the prior art LED lighting circuit includes a rectifier 310, a LED module 320, and a controller 330.

The rectifier 310, usually a full-wave bridge rectifier, is used to rectify an AC voltage V_{ac} to generate a line voltage V_{LINE}.

The LED module 320, including a first plurality of LEDs and a second plurality of LEDs connected in series, is powered by the line voltage V_{LINE}.

The controller 330, including an amplifier 331, an NMOS transistor 332, and a current sensing resistor 333, is connected between the LED module 320 and a ground to regulate an output current I_{O} flowing through the LED module 320.

The amplifier 331 has a positive input end, a negative input end, and an output end, with the positive input end coupled to a DC reference voltage V_{REF}.

The NMOS transistor 332 has a gate terminal coupled to the output end of the amplifier 331, a drain terminal coupled to the top end of the second plurality of LEDs in the LED module 320, and a source terminal coupled to the bottom end of the second plurality of LEDs in the LED module 320 and to the negative input end of the amplifier 331.

The current sensing resistor 333 is coupled between the source terminal and the ground.

Due to a virtual short of the positive input end and the negative input end of the amplifier 331, the voltage across the current sensing resistor 333 will be regulated at the DC reference voltage V_{REF}, resulting in a constant value of the output current I_{O}.

When the AC voltage V_{ac} exceeds a threshold, the second plurality of LEDs of the LED module 320 will start to conduct to share a portion of the input power, and thereby prevent the controller 330 from receiving excess power. Please refer to FIG. 4, which illustrates a profile of P_{IN} (the power delivered into the LED lighting circuit) and a profile of P_{LED} (the power dissipated in the LED module 320) over the root-mean-square value V_{ac,rms} of the AC voltage V_{ac}. As can be seen in FIG. 4, the difference between P_{IN} and P_{LED} becomes bounded as V_{ac,rms} exceeds a threshold voltage V_{X}. Therefore, the heat generated in the controller 130 is well controlled and the thermal breakdown of the controller 130 can be prevented.

However, as the cost of the LED module 320 occupies a major portion of the LED lighting circuit, the including of the second plurality of LEDs into the LED module 320 will increase a lot of cost to the LED lighting circuit.

In view of the foregoing problems, the present invention proposes a novel LED lighting circuit, which is capable of preventing the thermal breakdown.

### SUMMARY OF THE INVENTION

The major objective of the present invention is to propose an LED lighting circuit capable of decreasing the current flowing through an LED module after a line voltage exceeds a threshold, to reduce the power dissipation in a controller and thereby prevent a thermal breakdown of the controller at high levels of the line voltage.

Another objective of the present invention is to propose an LED lighting circuit capable of generating an adjustable reference voltage which will decrease with the increase of a line voltage after the line voltage exceeds a threshold, so as to reduce the current flowing through an LED module and thereby prevent a thermal breakdown of the controller at high levels of the line voltage.

To achieve the foregoing objectives of the present invention, an LED lighting circuit capable of preventing thermal breakdown is proposed, the LED lighting circuit including a rectifier, an LED module, and a controller.

The rectifier is used to rectify an AC voltage to generate a line voltage.

The LED module, including at least one LED, has a top end and a bottom end, the top end being coupled to the line voltage.

The controller, coupled to the line voltage and the bottom end of the LED module, is used for regulating an output current flowing through the LED module, the controller including an amplifier, a transistor, a current sensing resistor, and a reference voltage generator.

The amplifier has a positive input end, a negative input end, and an output end, with the positive input end coupled to an adjustable reference voltage.

The transistor has a gate terminal coupled to the output end of the amplifier, a first channel terminal coupled to the bottom end of the LED module, and a second channel terminal coupled to the negative input end of the amplifier.

The current sensing resistor is coupled between the second channel terminal and a ground.

The reference voltage generator is used for generating the adjustable reference voltage according to the line voltage, wherein the adjustable reference voltage is at a DC level when the line voltage is below a threshold voltage, and the adjustable reference voltage decreases with the increase of the line voltage after the line voltage exceeds the threshold voltage.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a prior art LED lighting circuit.

FIG. 2 illustrates a profile of P_{IN} (the power delivered into the LED lighting circuit of FIG. 1) and a profile of P_{LED} (the power dissipated in the LED module of FIG. 1) over the root-mean-square value V_{ac,rms} of an AC voltage V_{ac}.

FIG. 3 illustrates a prior art LED lighting circuit using additional LEDs.

FIG. 4 illustrates a profile of P_{IN} (the power delivered into the LED lighting circuit of FIG. 3) and a profile of P_{LED} (the power dissipated in the LED module of FIG. 3) over the root-mean-square value V_{ac,rms} of an AC voltage V_{ac}.

FIG. 5 illustrates a profile of P_{IN} (the power delivered into an LED lighting circuit) and a profile of P_{LED} (the power dissipated in an LED module) over the root-mean-square value V_{ac,rms} of an AC voltage V_{ac} according to the present invention.

FIG. 6 illustrates the block diagram of an LED lighting circuit according to a preferred embodiment of the present invention.

FIG. 7 illustrates the block diagram of an LED lighting circuit according to another preferred embodiment of the present invention.

FIG. 8 illustrates the block diagram of an LED lighting circuit according to still another preferred embodiment of the present invention.

FIG. 9 illustrates the block diagram of an LED lighting circuit according to still another preferred embodiment of the present invention.

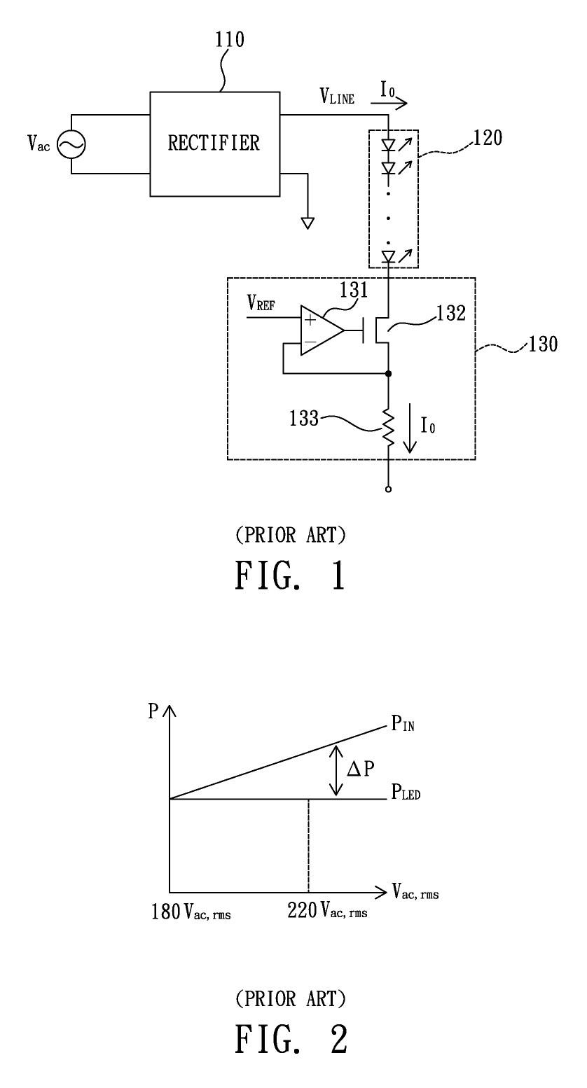

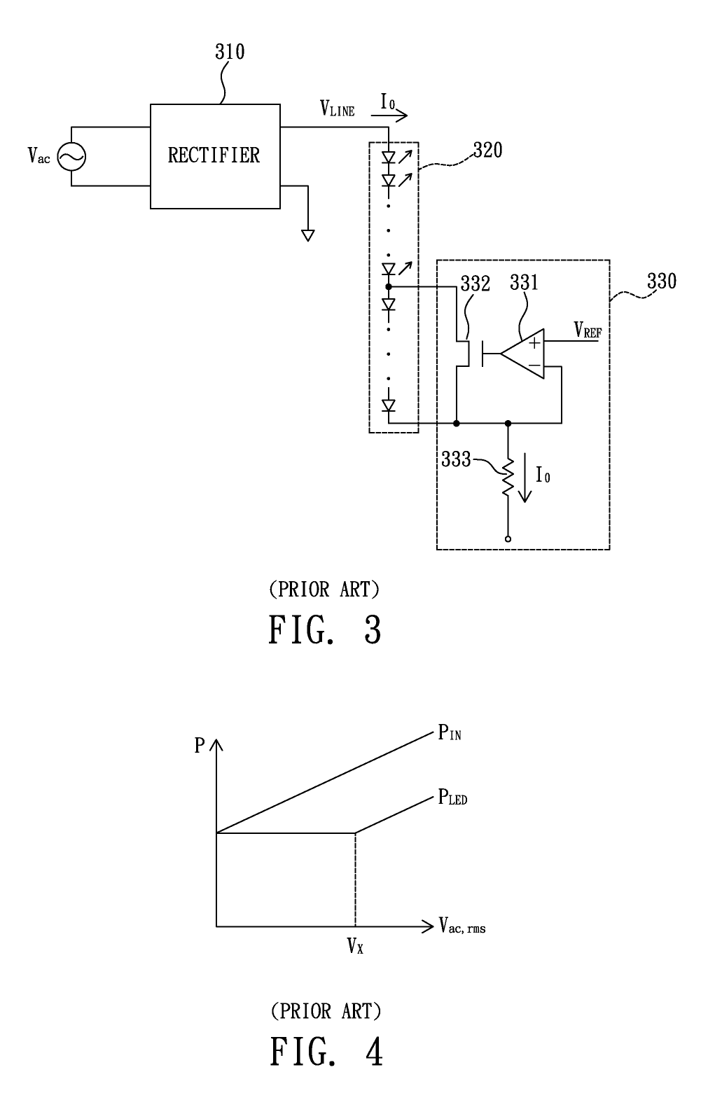

### DETAILED DESCRIPTION OF THE PREFERRED EMBODIMENTS

The present invention will be described in more detail hereinafter with reference to the accompanying drawings that show the preferred embodiments of the invention.

To prevent a thermal breakdown of an LED lighting circuit occurring at high root-mean-square values of an AC voltage, the present invention proposes a novel mechanism to decrease the power consumption in both the LED lighting circuit and an LED module therein after the root-mean-square value of the AC voltage exceeds a threshold.

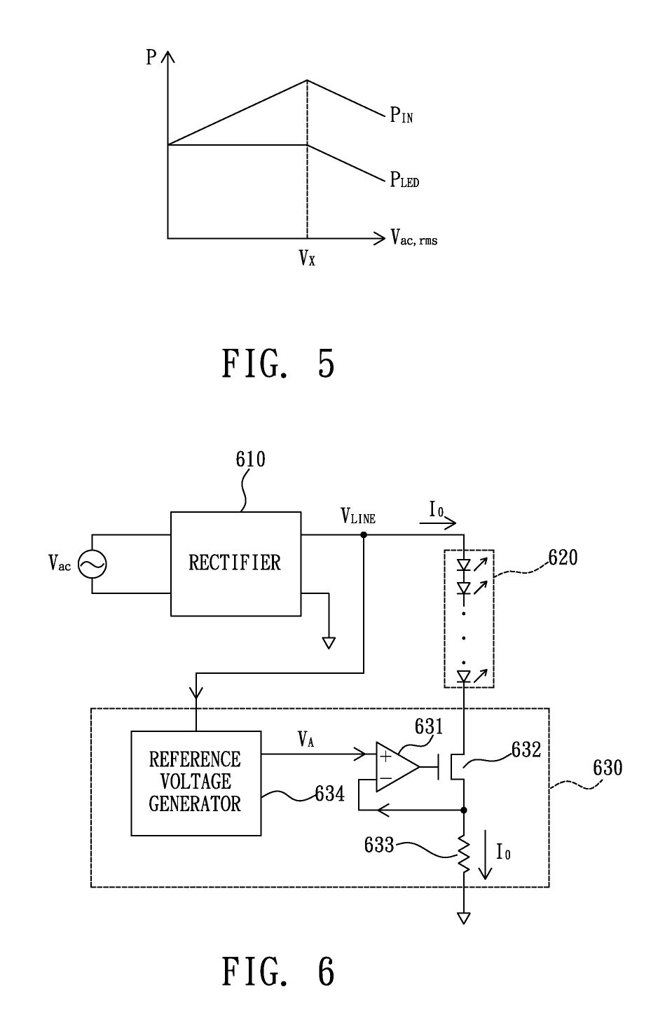

Please refer to FIG. 5, which illustrates a profile of P_{IN} (the power delivered into an LED lighting circuit) and a profile of P_{LED} (the power dissipated in an LED module) over the root-mean-square value V_{ac,rms} of an AC voltage V_{ac} according to the present invention. As can be seen in FIG. 5, both P_{IN} and P_{LED} start to decrease with the increase of V_{ac,rms} and the difference between P_{IN} and P_{LED} is bounded after V_{ac,rms} exceeds a threshold voltage V_{X}. By this arrangement, the heat generated in the LED lighting circuit will be well controlled to prevent the thermal breakdown that can happen at high root-mean-square values of the AC voltage.

Based on the profiles of P_{IN} and P_{LED} in FIG. 5, the present invention proposes an LED lighting circuit. Please refer to FIG. 6, which illustrates the block diagram of an LED lighting circuit according to a preferred embodiment of the present invention. As illustrated in FIG. 6, the LED lighting circuit includes a rectifier 610, an LED module 620, and a controller 630.

The rectifier 610, usually a full-wave bridge rectifier, is used to rectify an AC voltage V_{ac} to generate a line voltage V_{LINE}.

The LED module 620, including a plurality of LEDs connected in series, has a top end and a bottom end, the top end being coupled to the line voltage V_{LINE}.

The controller 630, including an amplifier 631, an NMOS transistor 632, a current sensing resistor 633, and a reference voltage generator 634, is coupled to the line voltage V_{LINE} and the bottom end of the LED module 620, and used to regulate an output current I_{O} flowing through the LED module 620.

The amplifier 631 has a positive input end, a negative input end, and an output end, with the positive input end coupled to an adjustable reference voltage V_{A}.

The NMOS transistor 632 has a gate terminal coupled to the output end of the amplifier 631, a first channel terminal—a drain terminal—coupled to the bottom end of the LED module 620, and a second channel terminal—a source terminal—coupled to the negative input end of the amplifier 631.

The current sensing resistor 633 is coupled between the source terminal and a ground.

The reference voltage generator 634 is used for generating the adjustable reference voltage V_{A} according to the line voltage V_{LINE}, wherein the adjustable reference voltage V_{A} is at a DC level when the line voltage V_{LINE} is below a threshold voltage, and the adjustable reference voltage V_{A} decreases with the increase of the line voltage V_{LINE} after the line voltage V_{LINE} exceeds the threshold voltage.

Due to the virtual short of the positive input end and the negative input end of the amplifier 631, the voltage across the current sensing resistor 633 will be regulated at the adjustable reference voltage V_{A}, resulting in a constant value of the output current I_{O} when V_{LINE} is below the threshold voltage, and causing the output current I_{O} to decrease with the increase of V_{LINE} after V_{LINE} exceeds the threshold voltage. Using this arrangement, the profiles in FIG. 5 can be achieved.

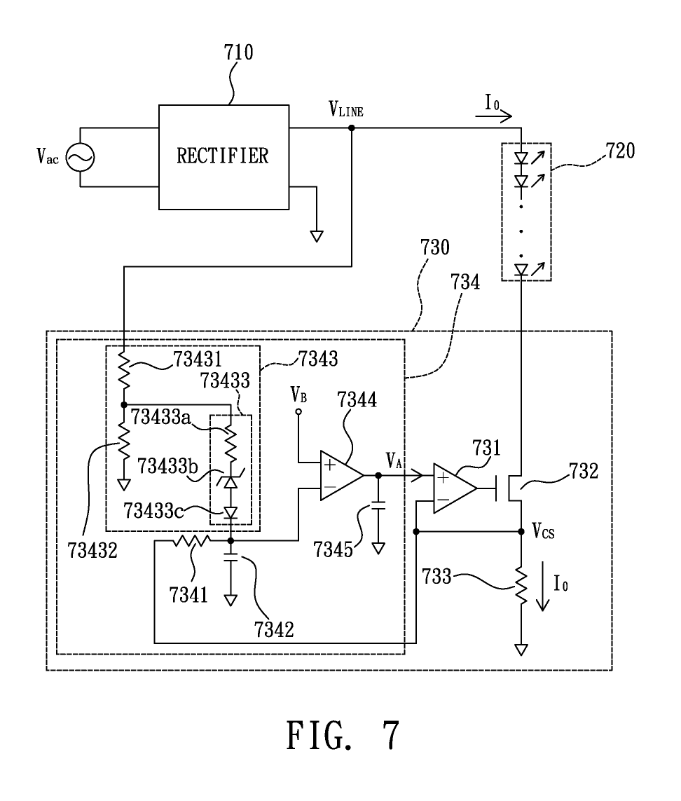

Based on the profiles of P_{IN} and P_{LED} in FIG. 5, the present invention proposes another LED lighting circuit. Please refer to FIG. 7, which illustrates the block diagram of an LED lighting circuit according to another preferred embodiment of the present invention. As illustrated in FIG. 7, the LED lighting circuit includes a rectifier 710, an LED module 720, and a controller 730.

The rectifier 710, usually a full-wave bridge rectifier, is used to rectify an AC voltage V_{ac} to generate a line voltage V_{LINE}.

The LED module 720, including a plurality of LEDs connected in series, has a top end and a bottom end, the top end being coupled to the line voltage V_{LINE}.

The controller 730, coupled to the line voltage V_{LINE} and the bottom end of the LED module 720, is used for regulating an output current I_{O} flowing through the LED module 720. The controller 730 includes a first amplifier 731, a transistor 732, a current sensing resistor 733, and a reference voltage generator 734, wherein the reference voltage generator 734 includes a first resistor 7341, a first capacitor 7342, a current source 7343, a second amplifier 7344, and a second capacitor 7345.

The first amplifier 731 has a first positive input end, a first negative input end, and a first output end, with the first positive input end coupled to an adjustable reference voltage V_{A}.

The transistor 732, preferably an NMOS transistor, has a gate terminal coupled to the first output end of the first amplifier 731, a first channel terminal—a drain terminal—coupled to the bottom end of the LED module 720, and a second channel terminal—a source terminal—coupled to the first negative input end of the first amplifier 731.

The current sensing resistor 733 is coupled between the second channel terminal and a ground for generating a current sensing voltage V_{CS}.

The first resistor 7341 has one end coupled to the first negative input end of the first amplifier 731, and another end coupled to a first common end.

The first capacitor 7342, having one end coupled to the first common end, and another end coupled to the ground, is used for eliminating a low frequency ripple at the first common end.

The current source 7343, including a second resistor 73431, a third resistor 73432, and a switch circuit 73433, is used to provide a current flowing through the first resistor 7341 according to the line voltage V_{LINE}, wherein the current source 7343 is shut off when the line voltage V_{LINE} is below a threshold voltage, and provides a current which increases with the line voltage V_{LINE} after the line voltage V_{LINE} exceeds the threshold voltage.

The second resistor 73431 has one end coupled to the line voltage V_{LINE} and another end coupled to a second common end.

The third resistor 73432 has one end coupled to the second common end, and another end coupled to the ground.

The switch circuit 73433, preferably including a fourth resistor 73433a, a zener diode 73433b, and a diode 73433c, has one end coupled to the second common end, and another end coupled to the first common end. The fourth resistor 73433a, the zener diode 73433b, and the diode 73433c are connected in series.

In one embodiment as illustrated in FIG. 7, the fourth resistor 73433a has one end coupled to the second common end, and another end coupled to the zener diode 73433b; the zener diode 73433b has a cathode coupled to the fourth resistor 73433a, and an anode coupled to the diode 73433c; and the diode 73433c has an anode coupled to the anode of the zener diode 73433b, and has a cathode coupled to the first common end. In other embodiments, the connection relationships among the fourth resistor 73433a, the zener diode 73433b, and the diode 73433c can be different, and the fourth resistor 73433a can be omitted.

The second amplifier 7344 has a second positive input end, a second negative input end, and a second output end, with the second positive input end coupled to a DC voltage V_{B}, the second negative input end coupled to the first common end, and the second output end for providing the adjustable reference voltage V_{A}.

The second capacitor 7345 is coupled between the second output end and the ground to eliminate a low frequency ripple at the second output end.

When the LED lighting circuit of FIG. 7 is in operation, a negative feedback loop including the first amplifier 731 and the second amplifier 7344 will be formed inside the controller 730. Due to a virtual short of the first positive input end and the first negative input end of the first amplifier 731 caused by the negative feedback loop, the voltage at the first negative input end will be very close to the voltage at the first positive input end; and due to a virtual short of the second positive input end and the second negative input end of the second amplifier 7344 caused by the negative feedback loop, the voltage at the second negative input end will be very close to the voltage at the second positive input end.

When the line voltage V_{LINE} is below a threshold set according to a breakdown voltage of the zener diode 73433b and a forward conduction voltage of the diode 73433c, the switch circuit 73433 will be off, and the second amplifier 7344 will set V_{A} at one level to make the average level of Vᵢₛ equal to V_{B}.

When the line voltage V_{LINE} exceeds the threshold, the zener diode 73433b and the diode 73433c will be turned on and a current will flow through the first resistor 7341, and the second amplifier 7344 will set V_{A} at a lower level to make the average level of Vᵢₛ lower than V_{B}. As the current flowing through the first resistor 7341 will increase with the line voltage V_{LINE} after the line voltage V_{LINE} exceeds the threshold, V_{A} will then decrease with the increase of the line voltage V_{LINE}, and so does the average of the output current I_{O}, to prevent the LED lighting circuit from entering a thermal breakdown.

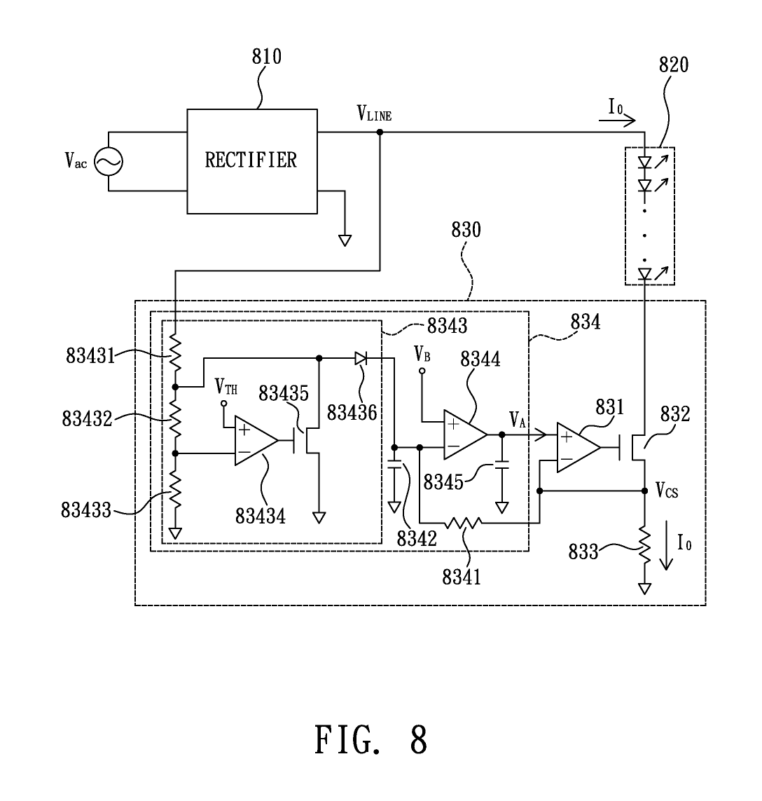

Based on the profiles of P_{IN} and P_{LED} in FIG. 5, the present invention proposes still another LED lighting circuit. Please refer to FIG. 8, which illustrates the block diagram of an LED lighting circuit according to still another preferred embodiment of the present invention. As illustrated in FIG. 8, the LED lighting circuit includes a rectifier 810, an LED module 820, and a controller 830.

The rectifier 810, usually a full-wave bridge rectifier, is used to rectify an AC voltage V_{ac} to generate a line voltage V_{LINE}.

The LED module 820, including a plurality of LEDs connected in series, has a top end and a bottom end, the top end being coupled to the line voltage V_{LINE}.

The controller 830, coupled to the line voltage V_{LINE} and the bottom end of the LED module 820, is used for regulating an output current I_{O} flowing through the LED module 820, the controller 830 including a first amplifier 831, a first transistor 832, a current sensing resistor 833, and a reference voltage generator 834.

The first amplifier 831 has a first positive input end, a first negative input end, and a first output end, with the first positive input end coupled to an adjustable reference voltage V_{A}.

The first transistor 832, preferably an NMOS transistor, has a gate terminal coupled to the first output end of the first amplifier 831, a first channel terminal—a drain terminal—coupled to the bottom end of the LED module 820, and a second channel terminal—a source terminal—coupled to the first negative input end of the first amplifier 831.

The current sensing resistor 833 is coupled between the second channel terminal of the first transistor 832 and a ground for generating a current sensing voltage V_{CS}.

The reference voltage generator 834 includes a first resistor 8341, a first capacitor 8342, a current source 8343, a second amplifier 8344, and a second capacitor 8345

The first resistor 8341 has one end coupled to the first negative input end of the first amplifier 831, and another end coupled to a first common end.

The first capacitor 8342, having one end coupled to the first common end, and another end coupled to the ground, is used for eliminating a low frequency ripple at the first common end.

The current source 8343, including a second resistor 83431, a third resistor 83432, a fourth resistor 83433, a comparator 83434, a second transistor 83435, and a diode 83436, is used to provide a current flowing through the first resistor 8341 according to the line voltage V_{LINE}, wherein the current source 8343 is shut off when the line voltage V_{LINE} is below a threshold voltage, and provides a current which increases with the line voltage V_{LINE} after the line voltage V_{LINE} exceeds the threshold voltage.

The second resistor 83431 has one end coupled to the line voltage V_{LINE} and another end coupled to a second common end.

The third resistor 83432 has one end coupled to the second common end, and another end coupled to a third common end.

The fourth resistor 83433 has one end coupled to the third common end, and another end coupled to the ground.

The comparator 83434 has a positive input end coupled to a DC voltage V_{TH}, a negative input end coupled to the third common end, and an output end coupled to the second transistor 83435.

The second transistor 83435, preferably an NMOS transistor, has a gate terminal coupled to the output end of the comparator 83434, a first channel terminal—a drain terminal—coupled to the second common end, and a second channel terminal—a source terminal—coupled to the ground.

The diode 83436 has an anode coupled to the second common end, and has a cathode coupled to the first common end.

The second amplifier 8344 has a second positive input end, a second negative input end, and a second output end, with the second positive input end coupled to a DC voltage V_{B}, the second negative input end coupled to the first common end, and the second output end for providing the adjustable reference voltage V_{A}.

The second capacitor 8345 is coupled between the second output end and the ground to eliminate a low frequency ripple at the second output end.

When the LED lighting circuit of FIG. 8 is in operation, a negative feedback loop including the first amplifier 831 and the second amplifier 8344 will be formed inside the controller 830. Due to a virtual short of the first positive input end and the first negative input end of the first amplifier 831 caused by the negative feedback loop, the voltage at the first negative input end will be very close to the voltage at the first positive input end; and due to a virtual short of the second positive input end and the second negative input end of the second amplifier 8348 caused by the negative feedback loop, the voltage at the second negative input end will be very close to the voltage at the second positive input end.

When the line voltage V_{LINE} is below a threshold set according to the first DC voltage V_{TH}, the voltage at the output end of the comparator 83434 will be at a high level to turn on the second transistor 83435 and thereby turn off the diode 83436, and the second amplifier 8344 will set V_{A} at one level to make the average level of V_{CS} equal to V_{B}.

When the line voltage V_{LINE} exceeds the threshold, the output voltage of the comparator 83434 will be at a low level to turn off the second transistor 83435 and thereby turn on the diode 83436 to generate a current flowing through the first resistor 8341, and the second amplifier 8344 will set V_{A} at a lower level to make the average level of V_{CS} lower than V_{B}. As the current flowing through the first resistor 8341 will increase with the line voltage V_{LINE} after the line voltage V_{LINE} exceeds the threshold, V_{A} will then decrease with the increase of the line voltage V_{LINE}, and so does the average of the output current I_{O}, to prevent the LED lighting circuit from entering a thermal breakdown.

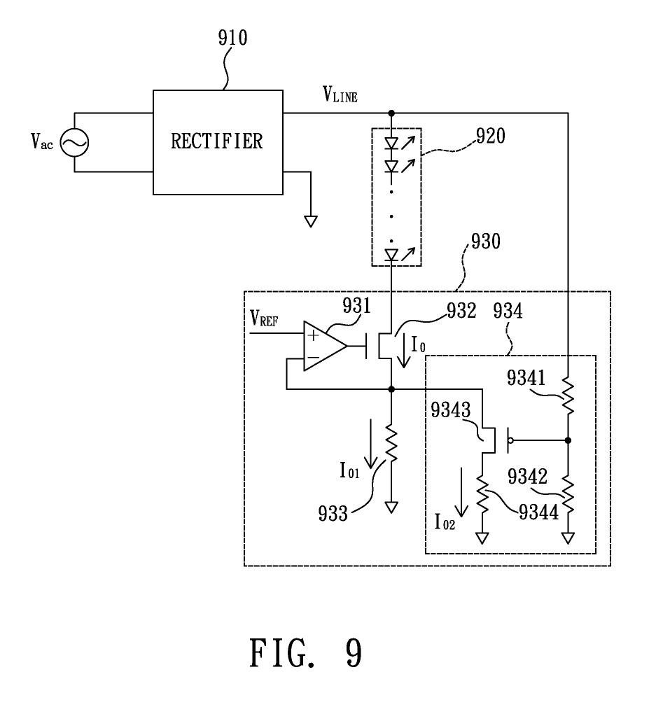

Based on the profiles of P_{IN} and P_{LED} in FIG. 5, the present invention proposes still another LED lighting circuit. Please refer to FIG. 9, which illustrates the block diagram of an LED lighting circuit according to still another preferred embodiment of the present invention. As illustrated in FIG. 9, the LED lighting circuit includes a rectifier 910, an LED module 920, and a controller 930.

The rectifier 910, usually a full-wave bridge rectifier, is used to rectify an AC voltage V_{ac} to generate a line voltage V_{LINE}.

The LED module 920, including a plurality of LEDs connected in series, has a top end and a bottom end, the top end being coupled to the line voltage V_{LINE}.

The controller 930, coupled to the line voltage V_{LINE} and the bottom end of the LED module 920, is used for regulating an output current I_{O} flowing through the LED module 920. The controller 930 includes an amplifier 931, a first transistor 932, a current sensing resistor 933, and a current source 934.

The amplifier 931 has a positive input end, a negative input end, and an output end, with the positive input end coupled to a reference voltage V_{REF}.

The first transistor 932, preferably an NMOS transistor, has a gate terminal coupled to the output end of the first amplifier 931, a first channel terminal—a drain terminal—coupled to the bottom end of the LED module 920, and a second channel terminal—a source terminal—coupled to the negative input end of the amplifier 931.

The current sensing resistor 933, coupled between the second channel terminal of the first transistor 932 and a ground, carries a first current I_{O1}.

The current source 934, including a first resistor 9341, a second resistor 9342, a second transistor 9343, and a third resistor 9344, is used to draw a second current I_{O2} from the output current I_{O} according to the line voltage V_{LINE}, wherein the average of the second current I_{O2} decreases with the increase of the line voltage V_{LINE}.

The first resistor 9341 has one end coupled to the line voltage V_{LINE}, and another end coupled to a first common end.

The second resistor 9342, having one end coupled to the first common end, and another end coupled to the ground.

The second transistor 9343, preferably a PMOS transistor, has a gate terminal coupled to the first common end, a first channel terminal—a source terminal—coupled to the second channel terminal of the first transistor 932, and a second channel terminal—a drain terminal—coupled to the third resistor 9344.

The third resistor 9344 is coupled between the second channel terminal of the second transistor 9343 and the ground.

When the LED lighting circuit of FIG. 9 is in operation, a negative feedback loop including the first amplifier 931 will be formed inside the controller 930. Due to a virtual short of the first positive input end and the first negative input end of the first amplifier 931 caused by the negative feedback loop, the voltage at the first negative input end will be very close to the voltage at the first positive input end.

When the line voltage V_{LINE} is below a threshold, which is determined by a forward voltage dropt of the LED module 920, the average of the output current I_{O} will be approximately a constant due to the combination of the first current I_{O1}, of which the average increases with the line voltage V_{LINE}, and the second current I_{O2}, of which the average decreases with the line voltage V_{LINE}. The phenomenon that the average of the first current I_{O1} increases with the line voltage V_{LINE} is explained as follows: as the line voltage V_{LINE} increases in amplitude, more portion of the line voltage V_{LINE} will be higher than the forward voltage dropt of the LED module 920, and the average of the first current I_{O1} will increase accordingly.

When the line voltage V_{LINE} exceeds the threshold, the increase of the average of the first current I_{O1} with the line voltage V_{LINE} will be non-obvious, causing the average of the output current I_{O} to decrease with the increase of the line voltage V_{LINE} and thereby prevent the LED lighting circuit from entering a thermal breakdown.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An LED lighting circuit capable of preventing thermal breakdown, comprising:
an LED module, having a top end and a bottom end, said top end being coupled to a line voltage; and
a controller, coupled to said line voltage and said bottom end of said LED module for regulating an output current flowing through said LED module, said controller including:
an amplifier, having a positive input end, a negative input end, and an output end, with said positive input end coupled to an adjustable reference voltage;
a transistor, having a gate terminal coupled to said output end of said amplifier, a first channel terminal coupled to said bottom end of said LED module, and a second channel terminal coupled to said negative input end of said amplifier;
a current sensing resistor, coupled between said second channel terminal and a ground; and
a reference voltage generator, used for generating said adjustable reference voltage according to said line voltage, wherein said adjustable reference voltage is at a DC level when said line voltage is below a threshold voltage, and said adjustable reference voltage decreases with the increase of said line voltage after said line voltage exceeds said threshold voltage.

2. The LED lighting circuit capable of preventing thermal breakdown as claim 1, further comprising a rectifier, used to rectify an AC voltage to generate said line voltage.

3. The LED lighting circuit capable of preventing thermal breakdown as claim 1, wherein said transistor is an NMOS transistor.

4. An LED lighting circuit capable of preventing thermal breakdown, comprising:
an LED module, having a top end and a bottom end, said top end being coupled to a line voltage;
a first amplifier, having a first positive input end, a first negative input end, and a first output end, with said first positive input end coupled to an adjustable reference voltage;
a first transistor, having a gate terminal coupled to said first output end of said first amplifier, a first channel terminal coupled to said bottom end of said LED module, and a second channel terminal coupled to said first negative input end of said first amplifier;
a current sensing resistor, coupled between said second channel terminal of said first transistor and a ground;
a first resistor, having one end coupled to said first negative input end of said first amplifier, and another end coupled to a first common end;
a current source, coupled between said line voltage and said first common end for providing a current flowing through said first resistor according to said line voltage, wherein said current source is shut off when said line voltage is below a threshold voltage, and provides a current which increases with said line voltage after said line voltage exceeds said threshold voltage; and
a second amplifier, having a second positive input end, a second negative input end, and a second output end, with said second positive input end coupled to a first DC voltage, said second negative input end coupled to said first common end, and said second output end for providing said adjustable reference voltage.

5. The LED lighting circuit capable of preventing thermal breakdown as claim 4, further comprising a rectifier, used to rectify an AC voltage to generate said line voltage.

6. The LED lighting circuit capable of preventing thermal breakdown as claim 4, wherein said first transistor is an NMOS transistor.

7. The LED lighting circuit capable of preventing thermal breakdown as claim 4, further comprising a first capacitor, which has one end coupled to said first common end, and another end coupled to said ground.

8. The LED lighting circuit capable of preventing thermal breakdown as claim 7, further comprising a second capacitor, which is coupled between said second output end and said ground.

9. The LED lighting circuit capable of preventing thermal breakdown as claim 4, wherein said current source comprises:
a second resistor, having one end coupled to said line voltage and another end coupled to a second common end;
a third resistor, having one end coupled to said second common end, and another end coupled to said ground; and
a switch circuit, having one end coupled to said second common end, and another end coupled to said first common end, wherein said switch circuit is shut off when said line voltage is below said threshold voltage, and is turned on after said line voltage exceeds said threshold voltage.

10. The LED lighting circuit capable of preventing thermal breakdown as claim 9, wherein said switch circuit comprises a zener diode.

11. The LED lighting circuit capable of preventing thermal breakdown as claim 10, wherein said switch circuit further comprises a diode in series with said zener diode.

12. The LED lighting circuit capable of preventing thermal breakdown as claim 11, wherein said switch circuit further comprises a resistor in series with said zener diode and said diode.

13. The LED lighting circuit capable of preventing thermal breakdown as claim 4, wherein said current source comprises:
a second resistor, having one end coupled to said line voltage and another end coupled to a second common end;
a third resistor, having one end coupled to said second common end, and another end coupled to a third common end;
a fourth resistor, having one end coupled to said third common end, and another end coupled to said ground;
a comparator, having a positive input end, a negative input end and an output end, said positive input end being coupled to a second DC voltage, said negative input end being coupled to said third common end;
a second transistor, having a gate terminal coupled to said output end of said comparator, a first channel terminal coupled to said second common end, and a second channel terminal coupled to said ground; and
a diode, having an anode coupled to said second common end, and a cathode coupled to said first common end.

14. The LED lighting circuit capable of preventing thermal breakdown as claim 13, wherein said second transistor is an NMOS transistor.

15. An LED lighting circuit capable of preventing thermal breakdown, comprising:
an LED module, having a top end and a bottom end, said top end being coupled to a line voltage;
an amplifier, having a positive input end, a negative input end, and an output end, with said positive input end coupled to a reference voltage;
a first transistor, having a gate terminal coupled to said output end of said amplifier, a first channel terminal coupled to said bottom end of said LED module, and a second channel terminal coupled to said negative input end of said amplifier;
a current sensing resistor, coupled between said second channel terminal of said first transistor and a ground;
a first resistor, having one end coupled to said line voltage, and another end coupled to a first common end;
a second resistor, having one end coupled to said first common end and another end coupled to said ground;
a second transistor, having a gate terminal coupled to said first common end, a first channel terminal coupled to said second channel terminal of said first transistor, and a second channel terminal; and
a third resistor, having one end coupled to said second channel terminal of said second transistor, and another end coupled to said ground.

16. The LED lighting circuit capable of preventing thermal breakdown as claim 15, further comprising a rectifier, used to rectify an AC voltage to generate said line voltage.

17. The LED lighting circuit capable of preventing thermal breakdown as claim 15, wherein said first transistor is an NMOS transistor.

18. The LED lighting circuit capable of preventing thermal breakdown as claim 15, wherein said second transistor is a PMOS transistor.
